(19) United States
(12) Patent Application Publication
(10) Pub. No.: US 2005/0141398 A1
(43) Pub. Date: Jun. 30, 2005

(54) Optical device with a mobile optical element capable of interacting with an optical guide structure

(75) Inventor: Eric Ollier, Grenoble (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, PARIS (FR)

(21) Appl. No.: 11/010,376

(22) Filed: Dec. 14, 2004

(30) Foreign Application Priority Data
Dec. 29, 2003 (FR) 03 51220

(51) Int. Cl. G11B 7/24

(52) U.S. Cl. 369/275.1

(57) ABSTRACT

An optical device comprising an optical guide structure (10) for at least one optical beam (11), a mobile optical element (20) designed to interact or not interact with the optical beam using optical element displacement means (40), a flexible support (21) connecting the optical element to the optical guide structure. The device comprises a device (30) for positioning the optical element with respect to the optical guide structure, comprising a first mechanical reference (30.1) connected to the optical guide structure and a second mechanical reference (30.2) connected to the mobile optical element, and means (30.3) of crossconnecting the second mechanical reference and the first mechanical reference, this crossconnection enabling movement of the optical element according to at least one plane containing the first and second mechanical references (30.1, 30.2) and the optical guide structure (10). Use particularly in optical communications.

### TECHNICAL DOMAIN

This invention relates to an optical device with a mobile optical element capable of interacting with an optical guide structure. For example, this type of device is used for applications in the field of optical telecommunications and is used particularly for optical signal switching functions, for example in optical mixers capable of selectively putting one or several optical input channels into communication with one or several optical output channels.

Optical telecommunications are developing at a very sustained rate to face the increase in data traffic and the increased interest in Internet. The capacities of optical networks have considerably increased due to the introduction of dense wavelength multiplexing systems. There is an inescapable need to perform all optical switching functions, in other words without performing electrical switching after demodulating the optical signal.

### STATE OF PRIOR ART

The following text refers to documents numbered [1] to [14], for which the complete references are given at the end of the description. These documents illustrate various known optical switching devices.

Optical switches fall into two main families including firstly fully integrated switches and secondly switches provided with a mobile mechanical device.

Fully integrated optical switches include, for example, DOS (Digital Optical Switches) or MZI (Mach-Zehnder Interferometer) structures. They use thermo-optical or electro-optical properties of some materials, and their influence on the optical index to perform the switching function. Admittedly, switches of this type have the advantage that they can easily be integrated into an optical circuit, but suffer from limitations due to their sensitivity to the wavelength or polarization of light to be switched. Another limitation is their high energy consumption particularly for the thermo-optical actuator. Finally switches using the thermo-optical effect also suffer from a mediocre response time and are therefore slower.

Mechanical device switches are thus preferred in applications in which good insensitivity to polarization and the wavelength of the light to be switched is required. A distinction can be made between different types of these switches usually as a function of the mechanical device involved in switching.

Document [1] shows a switch based on the movement of an optical fiber. This type of switch has very weak video crosstalk, in other words very weak parasite coupling between adjacent switching channels. On the other hand, its manufacturing is made difficult by problems related to very precise alignment requirements between fibers. Its use is still limited mainly to small components. Document [2] also shows a switch with an optical guide. This optical guide is moved by an actuator integrated on the same chip. These switches may have a larger number of switching channels while maintaining the advantage of weak parasite coupling between channels (video crosstalk).

Documents [3], [4] and [5] propose to use micro-mirrors that could be inserted in light beams. Micro-mirror switches use a unique space for free propagation of light beams. Mirrors inserted in light beams to modify their trajectory can be displaced within this two or three-dimensional space. One of the main limitations encountered with this type of optical switch is due to the divergence of beams in the switching space in free space. This also limits the size of matrices containing several switches and causes serious difficulties in implementation (and therefore cost) of the connection with optical fibers. There is a tendency to introduce micro-lenses to widen and collimate the beams and alignment of the different components is very difficult.

In the configurations described in documents [4], [6], [7], light is guided by optical fibers and a mirror is inserted between the ends of the optical fibers to make a switching function. The mirror is moved in a plane that is either perpendicular to the plane in which the fibers are located or in a plane parallel to the plane of the fibers, by means of an electrostatic control.

One of the advantages of these configurations is that they recommend an optical fiber positioning device. Document [4] describes the use of flexible tabs etched in the substrate around cavities into which the optical fibers fit and documents [6] and [7] describe the properties of wet etching of silicon as a function of crystalline planes. On the other hand, the disadvantage of this approach is related to the manual assembly of optical fibers on a collective support on which mirrors are made, each associated with their mechanical displacement device. This induces an additional manufacturing cost and is not well adapted to the manufacture of matrices.

In other embodiments [8], [9], light is guided by optical guides, a mirror being inserted in a cavity separating two ends of coplanar guided optical channels.

Refer to FIGS. 1A, 1B that show such an elementary switch designed to cooperate with guided optical channels 1, 2. The light 3 guided by one of the channels 1 must propagate in the other channel 2 or be stopped to be directed to another optical channel (not shown in FIGS. 1A, 1B). The redirection to another channel can be seen in FIG. 1C.

The two guided optical channels 1, 2 are arranged within a substrate 100 and there is a housing 4 between two adjacent ends of the two guided optical channels 1, 2, capable of holding an optical appendage 5. When the optical appendage 5 is not in the housing 4, light 3 can propagate from one guided optical channel 1 to the other 2 by passing freely through the housing 4 (FIG. 1A). When the optical appendage 5 is placed in the housing 4, light 3 guided by one of the channels 1 or 2 can no longer propagate in the other channel 2 or 1 (FIG. 1B). It is stopped, either reflected or attenuated depending on the nature of the optical appendage 5 that may be a shutter, a mirror or a semi-reflecting slide.

In FIG. 1C, guided input optical channels 1.1, 1.2, 1.3, 1.4 are arranged in rows and guided output optical channels 2.1, 2.2, 2.3, 2.4 are arranged in columns. The housings 4 are at the intersection between a row and a column. Optical appendices 5 are placed in some of the housings 4.

In these embodiments, the optical appendage is mounted on a support that enables it to move in a plane perpendicular to the substrate or parallel to the substrate to interact or not interact with light. This support is fabricated on the same substrate as the optical guides in the same layer or sometimes using additional layers. In other cases, the guided optical channels and the housings are made on a substrate and the optical appendage and its support are made on another substrate, the two substrates then being assembled to each other.

Document [10] describes assembly using the flip-chip technique for a matrix of 2×2 switches based on silicon mirrors moving in the plane of the matrix with an optical guides matrix.

Patents [11], [12] and [13] show the assembly of mechanical devices including a mirror and optical guide circuits used to insert mirrors in cavities separating the optical guides with a displacement being made perpendicular to the substrate within which the optical guides circuit is located.

Document [14] also shows the flip-chip assembly of a MEMS (Micro-Electro-Mechanical System) type micro-mirror chip on an optical guide chip with a cavity, the movement of the micro-mirror being perpendicular to the plane of the chips. Solutions in which the displacement takes place in a plane perpendicular to the substrates plane lead to much more compact switches than if the displacement takes place in the plane of the substrate. Therefore these switches are advantageous for making matrices with a large number of input channels and output channels.

One disadvantage of these devices is that the relative positioning of the mirrors with guided optical channels is not satisfactory, particularly due to the support of the mirror and the displacement taking place in only one plane. This positioning is not dealt with specifically. The alignment quality generally depends on control of manufacturing. The alignment in lateral position and in angle is predominant in obtaining small optical losses. A precision of the order of a micrometer or even better is required and this cannot be achieved with most existing manufacturing techniques. This is the case particularly for configurations in which two substrates have to be assembled. Furthermore, solutions used for positioning optical fibers are not directly transposable.

### PRESENTATION OF THE INVENTION

The purpose of this invention is to propose an optical device comprising an optical guide structure for at least one optical beam, a mobile optical element designed to interact or not interact with the guided optical beam, without the limitations and difficulties described above.

The positioning precision of this optical device between the mobile optical element and the optical guide structure is much better than in the past. This better precision is acquired equally well if the mobile optical element and the optical guide structure are made on the same substrate, and if the optical guide structure is made on a first substrate and the mobile optical element is made on a second substrate, the two substrates being assembled afterwards, even imprecisely.

To achieve this, this invention includes a positioning device between the mobile optical element and the optical guide structure, this device comprising mechanical references related firstly to the optical element and secondly to the optical guide structure and means of crossconnecting the two mechanical references capable of displacing the optical element in at least one plane containing the mechanical references and the optical guide structure.

More precisely, this invention is an optical device comprising an optical guide structure for at least one optical beam, a mobile optical element designed to interact or not interact with the optical beam using optical element displacement means, a flexible support connecting the optical element to the optical guide structure, characterized in that it comprises a device for positioning the optical element with respect to the optical guide structure, comprising a first mechanical reference connected to the optical guide structure, a second mechanical reference connected to the mobile optical element, and means of crossconnecting the second mechanical reference and the first mechanical reference, this crossconnection enabling movement of the optical element according to at least one plane containing the first and second mechanical references and the optical guide structure.

The optical element is then capable of moving in translation and/or rotation. These movements can be made along at least one direction in space.

The crossconnection means and the displacement means are advantageously distinct, which makes it easier to achieve precise positioning of the mobile optical element with respect to the optical guide structure, this positioning not being modified during displacements of the optical element so that it is or it is not made to interact with an optical beam transported by the optical guide structure.

The crossconnection means may be passive, with the crossconnection being made once and for all during manufacture of the optical device. For example, this passive crossconnection may be obtained by tempering and deformation of a stressed mechanical structure, this deformation possibly being buckling.

In another embodiment, the crossconnection means are active and can be activated before and/or during and/or after displacement of the mobile optical element.

The crossconnection means may comprise at least one pair of electrodes, and one of the electrodes in the pair is mobile.

When there are several pairs of electrodes, the electrodes in the different pairs may extend in approximately perpendicular planes.

According to one advantageous embodiment, the second mechanical reference is flexibly connected to the mobile optical element through a flexible connection.

This flexible connection will preferably be thinner than the mobile electrode of the crossconnection means.

Advantageously from the manufacturing point of view, the flexible support, the second mechanical reference, the mobile optical element and the connection between the second mechanical reference and the optical element can form a mobile block.

The mobile block can support or form at least one mobile electrode of the crossconnection means and a mobile electrode of the displacement means.

The mobile optical element can enter into or move out of a cavity when it is displaced, and the optical guide structure opens up into this cavity.

The cavity may contain an index adaptation fluid to reduce insertion losses.

Means of displacement of the optical element can include a fixed electrode fixed to a protective cover of the optical element, in addition to a mobile electrode.

The first mechanical reference and the second mechanical reference may be chosen from among one or several surfaces, one or several parts with edges or points, or a combination of these elements.

In another embodiment, the first mechanical reference and the second mechanical reference may be chosen from among one or several protuberances, a housing for each protuberance or a combination of these elements.

The housing is preferably equipped with guide means for the protuberance. This avoids the use of one or several pairs of electrodes for the interconnection means.

The housing may be a V groove. In this configuration, the guide means may be the walls of the V groove.

In another embodiment, the guide means may be flexible tabs.

The optical guide structure comprises n guided optical channels on one side of the mobile optical element and m optical channels on the other side of the mobile optical element, where n and m are integers, at least one of them being greater than or equal to one.

A guided optical channel may be either an optical guide or an optical fiber.

The mobile optical element may be a semi-reflecting optical slide, a mirror, a shutter, a prism or a lens.

This invention also relates to an optical mixer that comprises several optical devices thus characterized, these optical devices being arranged in rows and columns, the optical guide structure of each optical device comprising two guided optical channels arranged at a non-zero angle on one side of the mobile optical element and two guided optical channels arranged at a non-zero angle on the other side of the mobile optical element, the said optical devices being connected in rows and/or in columns through their corresponding optical channels.

This invention also relates to a method of making an optical device thus characterized. This method includes the following steps:
on a first substrate, manufacture of the optical guide structure,
etching of a cavity in which the optical guide structure opens up and production of the first mechanical reference,
production of electrodes for the crossconnection means,
starting from a second substrate, delimitation of a mobile block including the second mechanical reference connected to the mobile optical element, and the flexible support,
assembly of the first substrate and the second turned over substrate,
release of the mobile block, keeping a mechanical connection with the first substrate,
starting from a third substrate, production of an electrode for the displacement means,
assembly of a cover above the second substrate, the electrode of the displacement means being located under the cover.

It also comprises a deposition step of a dielectric material to protect the electrodes.

The second substrate and the third substrate will advantageously be SOI substrates.

The step to release the mobile block may include thinning.

Electrodes may be deposited on the first substrate before the optical guide structure is made, and before the cavity in which the optical guide structure opens up is etched.

The etching step may be followed by a V groove etching step in the first substrate materializing the first mechanical reference.

In another configuration, the electrodes may be made after the etching step.

### BRIEF DESCRIPTION OF THE FIGURES

This invention will be better understood after reading the description of example embodiments given solely for information purposes and in no way limitative, with reference to the appended figures wherein:

FIGS. 1A, 1B (already described) illustrate the principle of an optical device with a switch function according to prior art, and FIG. 1C shows an optical mixer comprising several optical devices according to prior art;

FIGS. 2A, 2B illustrate an optical device according to the invention before and after positioning of the mobile optical element with respect to the optical guide structure;

FIG. 3 illustrates an optical device according to the invention in which the positioning device is passive;

FIGS. 4A to 4H are sectional or top views of several embodiments of optical devices according to the invention in which the positioning device is active;

FIGS. 5A to 5C and 6A to 6C show a top view and a sectional view of two other embodiments of an optical device according to the invention in which the second mechanical reference is formed from protuberances and the first mechanical reference is formed of housings for the protuberances;

FIGS. 7A to 7H illustrate several possible configurations for the optical guide structure and an optical mixer;

FIGS. 8A to 8D illustrate a first example of production steps on a first substrate of the optical guide structure and the first mechanical reference;

FIGS. 9A to 9C illustrate a first example of production steps for the mobile block including the optical element and the second mechanical reference, starting from a second substrate;

FIGS. 10A and 10B show the assembly of the first substrate in FIG. 8 with the second turned over substrate in FIG. 9 and release of the mobile block;

FIGS. 11A to 11D show the production of an electrode of the displacement means and how a cover is formed, starting from a third substrate;

FIGS. 12A and 12B show the assembly of the third substrate in FIG. 11 to the first two substrates in FIG. 10 and the production of holes for contacts;

FIGS. 13A to 13D illustrate a second example embodiment on a first substrate of the optical guide structure and the first mechanical reference;

FIGS. 14A, 14B illustrate a second example production steps for the mobile black including the optical element and the second mechanical reference, starting from a second substrate;

FIGS. 15A, 15B show the assembly of the first substrate in FIG. 13 to the second turned over substrate in FIG. 14 and release of the mobile block;

FIGS. 16A, 16B show the assembly of the third substrate of FIG. 11 to the first two substrates in FIG. 15 and the production of holes for contacts.

Identical, similar or equivalent parts in the different figures described below are marked with the same numeric references so as to facilitate the comparison between different figures.

The different parts shown in the figures are not necessarily drawn at the same scale, to make the figures more legible.

### DETAILED PRESENTATION OF PARTICULAR EMBODIMENTS

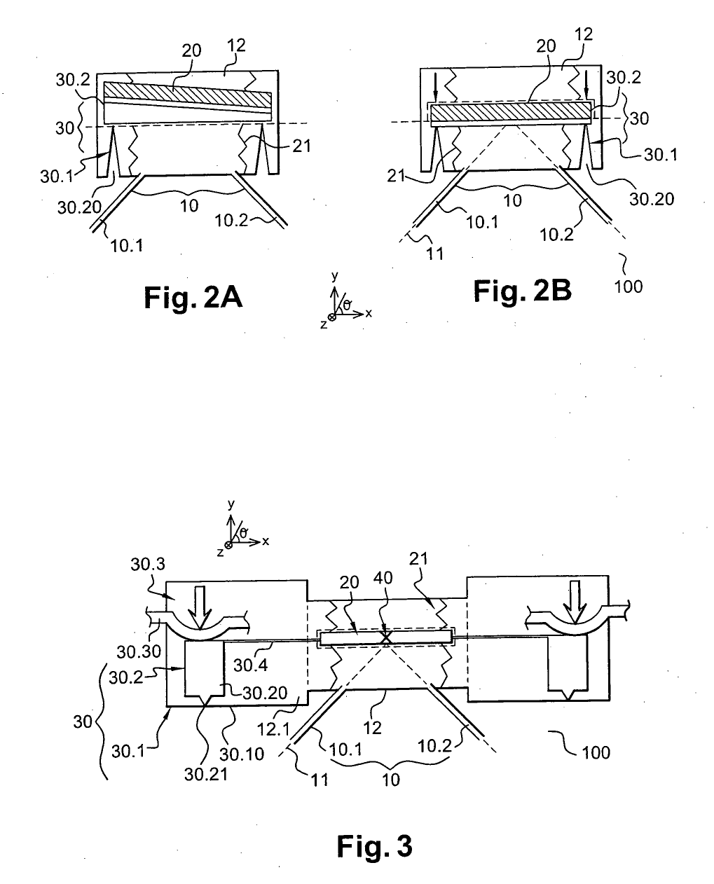

We will now describe a first embodiment of the optical device according to the invention with reference to FIGS. 2A, 2B that show top views. The optical device shown comprises an optical guide structure 10 comprising at least one guided optical channel. In the example, there are two guided optical channels 10.1, 10.2 that may be optical guides or optical fibers. The optical guide structure 10 is plane (xoy plane). The guided optical channels are designed to transport an optical beam 11. This optical guide structure 10 is fixed with respect to a base 100 with which it cooperates and which in the example is a substrate 100. It is located within the substrate.

The optical device also comprises a mobile optical element 20 including a mode in interaction with the optical beam 11 and a mode without interaction with the optical beam 11. This optical element 20 may be completely reflecting for the optical beam 11, or it may enable partial transmission of the optical beam 11, or it may be absorbing for the optical beam 11. It may be in the form of a mirror, a prism, a lens, a semi-reflecting optical slide or a shutter. It may be made from a dielectric material, metal or a semiconducting material. It may comprise a fluid between two slides, for example an index liquid or a liquid crystal. When the optical element 20 interacts with the optical beam 11, it is immersed in a cavity 12 into which the guided optical channels 10.1, 10.2 of the optical guide structure 10 open up.

The optical element 20 is mobile and is mechanically connected to the optical guide structure 10 which is advantageously fixed. This connection is usually indirect through a flexible support 21.

The optical device also comprises a positioning device 30 of the optical element 20 with respect to the optical guide structure 10. This positioning device 30 comprises at least one first mechanical reference 30.1 connected to the optical guide structure 10 (usually through the base 100) and a second mechanical reference 30.2 connected to the mobile optical element 20 and means 30.3 of crossconnecting the second mechanical reference 30.2 and the first mechanical reference 30.1. Creating this crossconnection enables a movement of the mobile optical element 20 in at least one plane containing the first mechanical reference 30.1, the second mechanical reference 30.2 and the optical guide structure 10. In these figures, the movement is made according to at least one translation in the plane defined above (xoy plane) and/or at least one rotation about the z-axis. With this type of authorized movement, crossconnecting the second mechanical reference- and the first mechanical reference enables extremely precise positioning of the optical element 20 with respect to the optical guide structure 10. This was not the case in prior art in which a positioning device was not specifically provided and furthermore the movement of the optical element 20 was only possible in a plane perpendicular to the plane defined above. If an angular deviation of the optical element was introduced accidentally, for example during assembly of the substrate carrying the optical element with the substrate carrying the optical guide structure, it was not eliminated. This coarse positioning caused optical losses, which was therefore not satisfactory.

The first mechanical reference 30.1 may be of the surface type and the second mechanical reference 30.2 may be a part with edges or points or other types, the points or the edge coming into contact with the surface after the positioning device 30 has been activated. In the example in FIGS. 2A, 2B, the first mechanical reference 30.1 is formed from two parts 30.20 each provided with an edge and the second mechanical reference 30.2 is formed from a plane surface. These edges are coplanar. The inverse would have been possible. Such a view could diagrammatically represent a part with points instead of a part with an edge.

The plane surface is one of the faces of the optical element 20 which in this example is in the form of a mirror. In FIG. 2A, the positioning device 30 has not yet been activated. The optical element 20 is not positioned correctly with respect to the optical guide structure 10; it must be subjected to a translation and at least one rotation to reach the required position. In FIG. 2B, the positioning device 30 has been activated, the first mechanical reference 30.1 is crossconnected, in this example is in contact, with the second mechanical reference 30.2. The means 30.3 of crossconnecting the first mechanical reference 30.1 with the second mechanical reference 30.2 are represented by two arrows that apply coplanar forces (xoy plane) to the optical element 20. These means will be described in detail later. After and/or before and/or during positioning, the optical element 20 may be displaced to be inserted into or removed from a cavity 12 in which each of the two guided optical channels 10.1, 10.2 of the optical guide structure 10 opens up.

FIG. 3 shows another configuration of an optical device according to the invention in which the first mechanical reference 30.1 is formed from two plane surfaces and the second mechanical reference 30.2 is formed from two parts each provided with an edge. When the crossconnection is made, the edges come into contact with the plane surfaces.

The optical guide structure 10, the cavity 12 and the optical element 20 are represented as shown in FIG. 2. The first mechanical reference 30.1 is formed from two plane surfaces oriented perpendicular to the plane of the optical guide structure 10. In the example, these plane surfaces are located in the xoz plane. The surfaces are walls of the auxiliary cavities 12.1 into which the second mechanical reference 30.2 will move when making the crossconnection.

The plane surfaces may for example be formed by walls of the cavity 12 into which the optical guide structure 10 opens up. It would be possible for a surface to correspond to the outside surface of a guided optical channel of the optical guide structure.

The second mechanical reference 30.2 is formed from two parts 30.20 each provided with an edge 30.1, these edges are parallel along the z-axis and are located on each side of the optical element 20. Each of them will come into contact with a plane surface 30.10 of the first mechanical reference 30.1. The parts 30.20 with an edge are mechanically connected to the optical element 20 through a connection 30.4, for example of the connecting arm type. The optical element 20 is approximately in the shape of a plate and the connection 30.4 extends on each side of the optical element 20. This connection 30.4 may be flexible, but this is not compulsory.

The means 30.3 of crossconnecting the second mechanical reference 30.2 and the first mechanical reference 30.1 may be passive. This crossconnection may be made during manufacturing of the optical device, for example using stress phenomena in materials. This embodiment is shown in FIG. 3. An auxiliary element 30.30 is stressed mechanically inducing an irreversible deformation, for example of the buckling type. When this auxiliary element 30.30 is deformed, it crossconnects the second mechanical reference 30.2 with the first mechanical reference 30.1 (in other words it brings the edge 30.21 into contact with the surface 30.10). This mechanical stress inducing buckling may be made by a thermal effect during manufacturing of the optical device according to the invention. In FIG. 3, the authorized movement is of the same type as that shown in FIGS. 2A, 2B.

In this case, after the crossconnection between the first and second mechanical references has been made, the device according to the invention is ready to operate, in other words when the optical element 20 is perfectly positioned with respect to the optical guide structure 10, it may or may not interact with an optical beam 11 guided by the optical guide structure 10. Means 40 of displacing the optical element 20 are provided to set up or eliminate this interaction by moving it into or out of the cavity 12, and this displacement must not modify the positioning that has been made between the second mechanical reference and the first mechanical reference. In FIG. 3, the means 40 of displacing the optical element 20 are symbolized by a cross.

As a variant, the means 30.3 of crossconnecting the second mechanical reference and the first mechanical reference may be active as will be seen later, and may be formed from electrostatic, electromagnetic or other actuators.

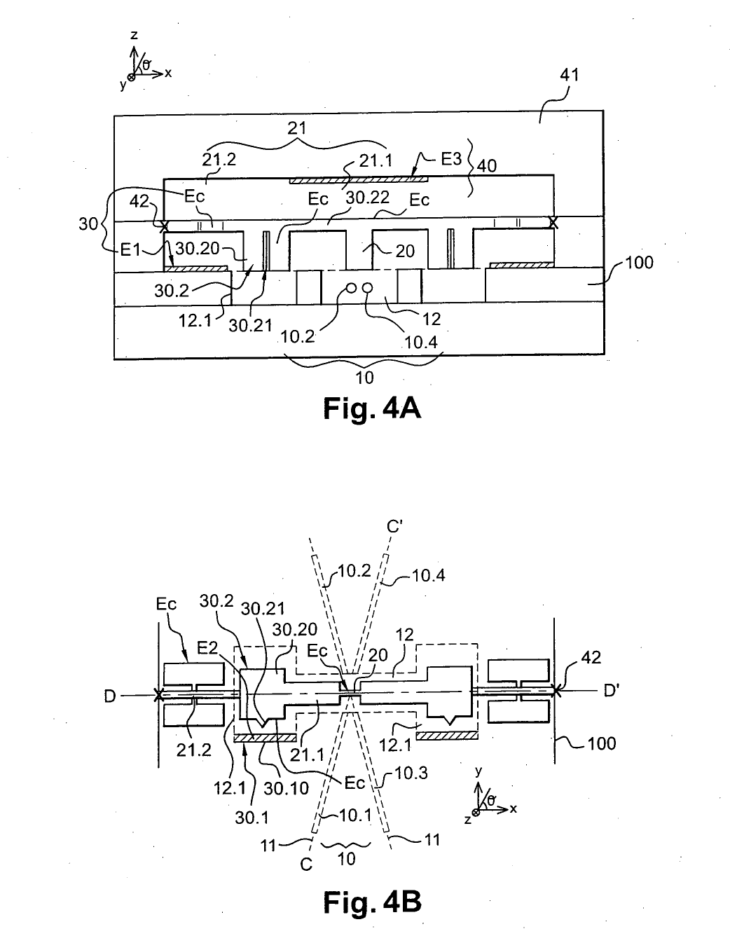

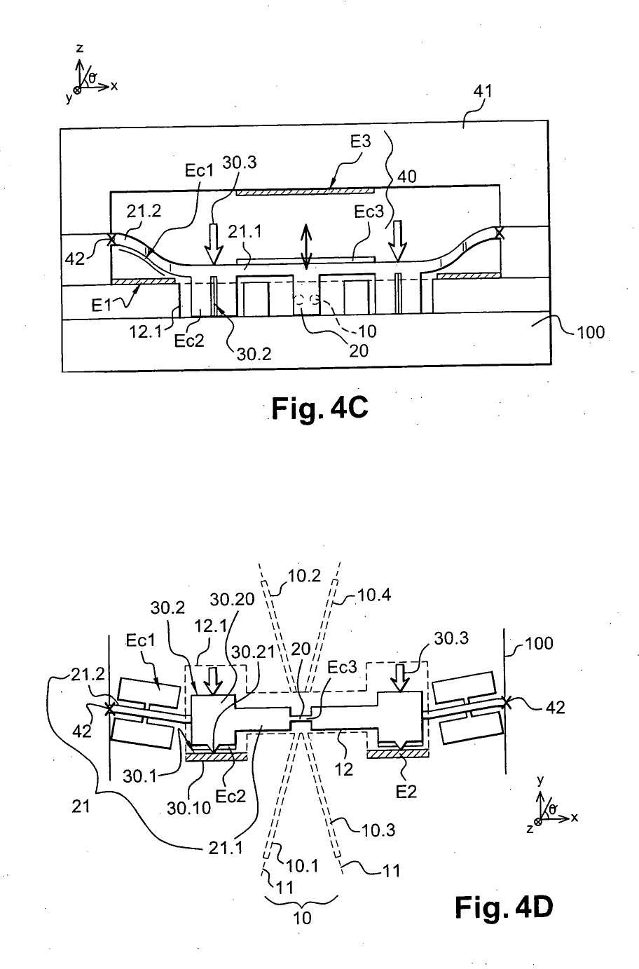

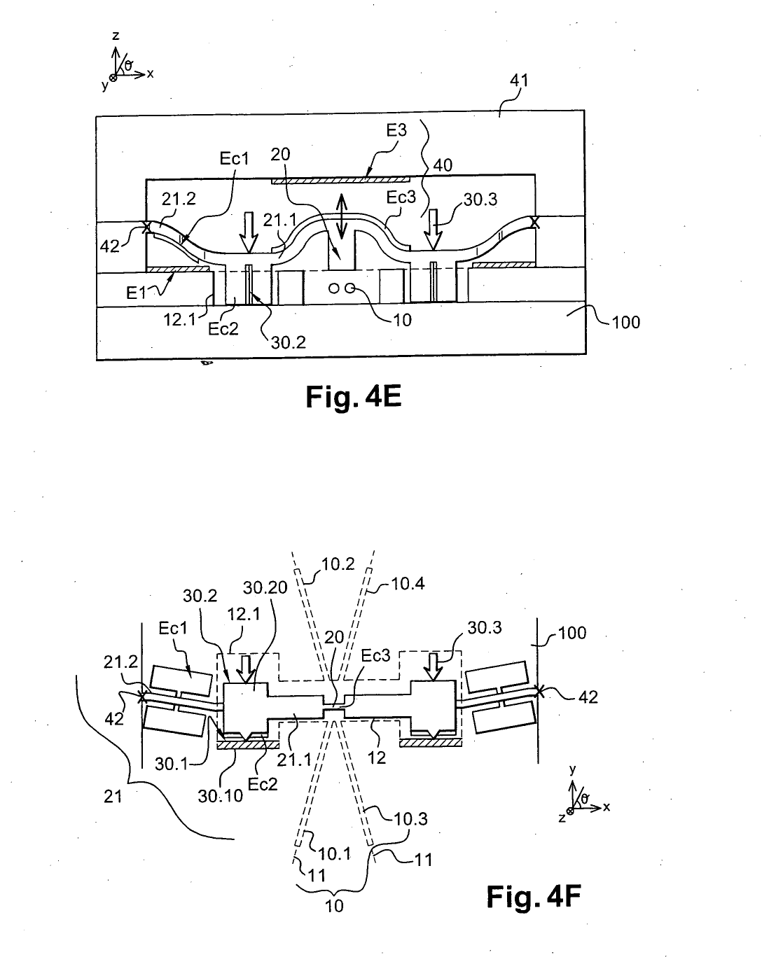

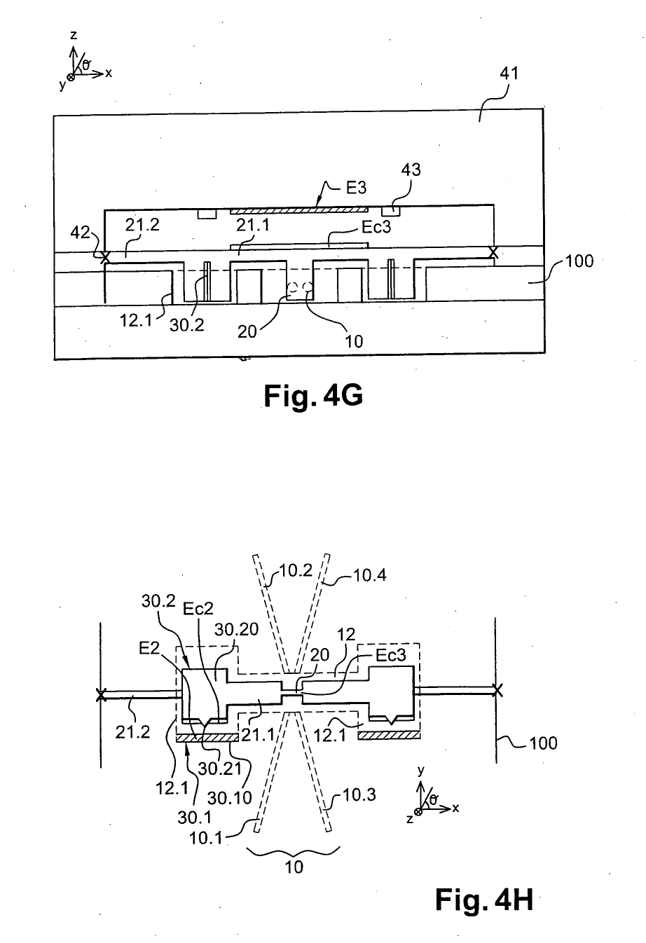

We will now refer to FIGS. 4A to 4H. In these figures, the optical device according to the invention is shown in a sectional view and a top view in several configurations. A first configuration is applicable before the second mechanical reference 30.2 is crossconnected to the first mechanical reference 30.1. At rest, by construction, the optical element 20 is either outside the cavity 12 (FIGS. 4A, 4B), or inside the cavity 12 (FIGS. 4G, 4H). A second configuration is applicable after the second mechanical reference has been crossconnected to the first mechanical reference. The optical element 20 is either inside the cavity (FIGS. 4C, 4D), or outside the cavity (FIGS. 4E, 4F).

In these examples, the first and second mechanical references are comparable to those in FIG. 3, except for the fact that the means of crossconnecting the second and first mechanical references are active and of the electrostatic actuator type.

The optical element 20 is in the form of a double-sided mirror. The means 40 of displacing the optical element 20 used to move it into or take it out of the cavity are also of the electrostatic type.

The optical guide structure 10 comprises four coplanar guided optical channels 10.1, 10.2, 10.3, 10.4 arranged approximately in X formation. One end of these four guided optical channels 10.1, 10.2, 10.3, 10.4 opens up in the cavity 12. Two of them (10.1, 10.3) are located on one side of the optical element 20 and the other two (10.2, 10.4) on the other side of the optical element 20 when it is inside the cavity 12.

The cavity 12 is excavated from a substrate 100 on which or in which the optical guide structure 10 is located. The optical guide structure extends in the xoy plane. The optical element 20 is central and is approximately plane oriented in the xoz plane. It is assumed that its displacement to move it into or to take it out of the cavity 12 takes place along the z direction. In these figures, it is suspended above the cavity 12 using a flexible support 21 that connects it to the optical guide structure 10 through the substrate 100. This flexible support 21 is in the form of two connecting arms 21, one prolonging the other, along the x direction. The second mechanical reference 30.2 is in the form of two parts with edges 30.20 as shown in FIG. 3. Each of these parts 30.20 is connected to the optical element 20 through a flexible connection 21.1 in the z direction that in this particular example forms part of one of the connecting arms 21 of the flexible support 21. In fact in this example, each connecting arm 21 comprises two segments 21.1, 21.2. Segment 21.1, close to the optical element, is fixed on one side to the optical element 20 and on the other side to the part with edges 30.20. It is flexible in the z direction. The other segment 21.2, far from the optical element 20, is fixed on one side to the part with edges 30.2 and on the other side to the substrate 100. It is flexible in the y and the z directions. In this case, the flexible connection between the second mechanical reference 30.2 and the optical element 20 is materialized by the segment 21.1 of the flexible support. In other configurations, this connection 30.4 would be distinct from the flexible support 21. The connection between the flexible support 21 and the substrate 100 may be an embedment reference 42 located in the segment 21.2. Therefore, the flexible support 21 indirectly connects the optical element 20 to the optical guide structure 10.

The means 30.3 of crossconnecting the second mechanical reference 30.2 with the first mechanical reference 30.1 are of the electrostatic type. They comprise two types of electrode pairs (Ec1, E1), (Ec2, E2) on each side of the optical element 20, the electrodes of one pair being attracted electrostatically when a control voltage is applied to them. FIG. 4C and subsequent figures show more details. Electrode pairs of one type are perpendicular to electrode pairs of the other type. One of the electrodes of a pair Ec1, Ec2 is mobile, in other words is fixed to the flexible support 21 and/or the flexible connection 30.4 and/or the second mechanical reference 30.2. In the examples, one of the mobile electrodes Ec1 is fixed to the segment 21.2 of the flexible support 21 close to the embedment 42. The second mobile electrode Ec2 is fixed to the part with edges 30.20.

The other electrode E1, E2 of a pair is fully fixed to the substrate 100. The application of a control voltage between each of these pairs of electrodes (Ec1, E1), (Ec2, E2) generates a movement of the second mechanical reference 30.2 to the first mechanical reference 30.1, this movement possibly being in three dimensions to enable translation and rotation of the optical element 20 when making the crossconnection. As mentioned above, the fixed electrodes E1, E2 of the two pairs are located in two perpendicular planes, namely the xoz plane (plane in which the optical element 20 moves to enter into and exit from the cavity 12) and the xoy plane (plane of the optical guide structure 10). Possibly, one of the electrodes of a pair is covered by a dielectric material as will be seen later, to electrically protect the electrodes in case of mechanical contact between electrodes.

The connecting arms 21 must be flexible in the attraction directions of each of the electrode pairs, namely in the z direction (direction of attraction of pairs Ec1, E1) and in the y direction (direction of attraction of the pair Ec2, E2). Other explanations about the flexibility of connecting arms will be given later.

One of the fixed electrodes E1, made on the substrate 100 and oriented in the plane of the optical guide structure 10 (xoy plane), is close to the embedment 42 of the flexible support 21 in the substrate 100.

The other fixed electrode E2 made on the substrate 100 and oriented perpendicular to the optical guide structure 10 in the displacement plane of the optical element 20 (xoz plane) is located at the part with edges 30.20.

The electrodes may be made by localized metallization, regardless of whether they are fixed or mobile.

Instead of having distinct mobile electrodes Ec1, Ec2 as shown in FIGS. 4C to 4H, the mobile electrodes can form a single common electrode Ec as shown in FIGS. 4A, 4B. In fact, the flexible support 21, the optical element 20 connected to the second mechanical reference 30.2 form a mobile block that is a single mobile electrode Ec. This mobile block may for example be made from a semiconducting material that may be doped or may be made of metal. In other configurations in which the mobile block would not be a sufficiently good conductor, the common electrode Ec could be deposited on the mobile block. Thus, this electrode Ec is common to the two pairs. During control, this electrode Ec could be increased to a predetermined potential, preferably the ground, while each of the fixed electrodes E1, E2 will be brought to appropriate potentials, usually different from each other to generate the appropriate movement of the optical element when crossconnecting the second mechanical reference 30.2 with the first mechanical reference 30.1.

In FIGS. 4A, 4B no positioning has been made between the optical element 20 and the optical guide structure 10. The second mechanical reference 30.2 and the first mechanical reference 30.1 have not yet been crossconnected. They are not in contact. Furthermore, the optical element 20 is located outside the cavity 12. The optical device according to the invention is not ready to operate.

In FIGS. 4C, 4D, the second mechanical reference 30.2 and the first mechanical reference 30.1 have been crossconnected and the optical element 20 has been inserted inside the cavity 12. Appropriate control voltages have been applied to electrode pairs E1, Ec1 and E2, Ec2. The part with edges 30.20 has been brought into contact with the surface 30.10 materializing the first mechanical reference. In this example, when making the crossconnection, the second mechanical reference moves in a space 12.1 that is an extension of the cavity 12. This is why the plane surface acting as the first mechanical reference may be treated as a wall of the cavity into which the guided optical channels 10.1 to 10.4 open up. As a variant, it could be a wall of an auxiliary cavity in which the part with edges 30.20 moves when the crossconnection is made. However, it is simpler if the space 12.1 communicates with the cavity 12. This surface is covered with a metallization materializing the fixed electrode E2. The electrode Ec2 may be very close to the electrode E2 at this stage.

The electrodes E1, Ec1 in the other pair are brought close to each other by an electrostatic effect, however in this example without coming into contact. At its extreme segment 21.2, the flexible support 21 is deformed in the xoz plane and also in the xoy plane.

The near segment 21.1 is almost undeformed at this stage. It is more rigid in the y direction than the far segment 21.2. It has only moved in the xoy plane and in the xoz plane, by pulling the optical element 20 along its path. The near segment 21.1 is wider (dimension along y) than the far segment 21.2, which is a means of obtaining the required stiffnesses.

The optical element 20 has entered the cavity 12. The optical device is in a reflection state (provided that the optical element 20 is a mirror) since the optical element 20 is in the cavity 12. An optical beam 11 transported by the guided optical channel 10.1 will be returned after reflection on one of the faces of the optical element 20, to the guided optical channel 10.3 located on the same side as the optical element 20. Similarly, an optical beam (not shown) transported by the guided optical channel 10.2 will be returned after reflection on the other side of the optical element 20, to the guided optical channel 10.4 located on the same side of the optical element 20 as the guided optical channel 10.2. The angle between the reflecting surface and the incident optical beam is determined to obtain this reflection. The result is thus elementary switching.

The means 40 of displacing the optical element 20 are also electrostatic. They comprise a pair of electrodes Ec3, E3, in which one Ec3 is mobile and the other E3 is fixed. The mobile electrode Ec3 is connected to the optical element 20. In the example in FIGS. 4A, 4B, it is materialized by the common electrode Ec. In the example in FIGS. 4C, 4D and 4E, 4F, it is independent. The fixed electrode E3 is fully fixed to a protection cover 41 that is fixed to the substrate 100 and that at least covers the cavity 12 and the optical element 20. This cover delimits a control space around the optical element 10. This fixed electrode E3 is located facing the optical element 20.

The application of a control voltage between the two electrodes Ec3 and E3 has the effect of bringing the two electrodes towards each other and therefore bending the near segment 21.2 in the xoz plane (plane in which the optical element 20 moves) and lifting the optical element 20 to bring it outside the cavity 12. This near segment 21.1 is sufficiently rigid in the xoy plane (plane of the optical guide structure) so as not to invalidate the crossconnection between the second mechanical reference 30.2 and the first mechanical reference 30.1. The means 40 of displacing the optical element 20, when they are activated, can deform the flexible support 21 at the near segment 21.1 and possibly the far segment 21.2 without invalidating the crossconnection between the first mechanical reference and the second mechanical reference. This state is represented in FIGS. 4E, 4F. It is preferable to avoid deformation of the far segment 21.2.

The optical device according to the invention is put into a transmission state. An incident optical beam 11 transported by the guided optical channel 10.1 passes through the cavity 12 and is propagated in the guided optical channel 10.4 that prolongs the guided optical channel 10.1. The same is true for an optical beam that would pass from the guided optical channel 10.2 to the guided optical channel 10.3.

If it is required to minimize insertion losses, it is recommended that an index adapting fluid (a liquid or gel) should be added at least into the cavity 12, these optical losses are due to propagation of the optical beam in the space between the guided optical channels and the optical element 20.

The electrostatic control of crossconnection means 30.3 and/or displacement means 40 may operate under stable conditions, in other words at least one mobile electrode moves between two extreme positions. For example, the control voltage confers a predetermined travel distance on the mobile electrode Ec3 and in one of these extreme positions, the mobile electrode Ec3 must not exceed a predetermined deformation amplitude, beyond which the mobile electrode Ec3 would move until it comes into contact with the fixed electrode if nothing stops it, if the control voltage is increased. The other extreme position corresponds to the case in which the optical element 20 stops in contact with the bottom of the cavity 12.

As a variant, the electrostatic control can operate within an unstable range. In this configuration, the mobile electrode Ec3 will have a travel distance such that the entire amplitude between electrodes can be used. The mobile electrode Ec3 may be stopped by insulating pads reference 43 or similar in FIG. 4G. For example, control by a structure with variable stiffness like that described in French patent application FR-2 818 825 could be envisaged, or possibly a mobile zipping effect electrode, in other words in which the mobile electrode is progressively brought into contact with the fixed electrode starting from its end.

FIGS. 4A to 4F show the authorized movement taking place in the xoy plane and the xoz plane for translations, and along the z-axis and the y-axis for rotations.

We will now refer to FIGS. 4G to 4H. The configuration in these figures is similar to the configuration in FIGS. 4A, 4B, the only difference being that the optical element 20 is located in the cavity 12, even before the crossconnection between the second mechanical reference 30.2 and the first mechanical reference 30.1 is made. Means 30.3 of making a crossconnection between the second mechanical reference 30.2 and the first mechanical reference 30.1 now only include a single type of electrode pairs, in which the mobile electrode Ec2 is located close to the second mechanical reference 30.2 and which enables displacement in the plane of the optical guide structure. The other type of electrode pairs is now superfluous. In each pair, the fixed electrode E2 is located at the level of each reference surface of the first mechanical reference 30.1 and the mobile electrode Ec2 is located close to the edge of the part with edges 30.20. Therefore the optical device comprises two electrode pairs (Ec2, E2) of the same type that enable the required positioning of the optical element 20 with respect to the optical guide structure 10. In FIGS. 4G, 4H the authorized movement is a movement in the plane containing the first and second mechanical references 30.1, 30.2 and the optical guide structure 10.

Thus, a translation of the second mechanical reference 30.2 in the z direction perpendicular to the plane of the optical guide structure 10 is not necessary when crossconnecting the mechanical reference 30.2 with the first mechanical reference 30.1 since the optical element 20 at rest is inside cavity 12, by construction.

The means 40 of displacing the optical element 20 are shown approximately with the same nature as in the previous figures. In this configuration shown in FIGS. 4G, 4H, the space between the electrode Ec3 and electrode E3 can be reduced. The control voltage to be input to the means 40 of displacing the optical element 20 may be smaller. This facilitates functional control of the optical device, in other words for example its change from the transmission state to the reflection state.

Particular geometries of mobile electrodes may be used to optimize operation of the optical device according to the invention. For example, refer to patent application FR-2 817 050 that shows electrode configurations.

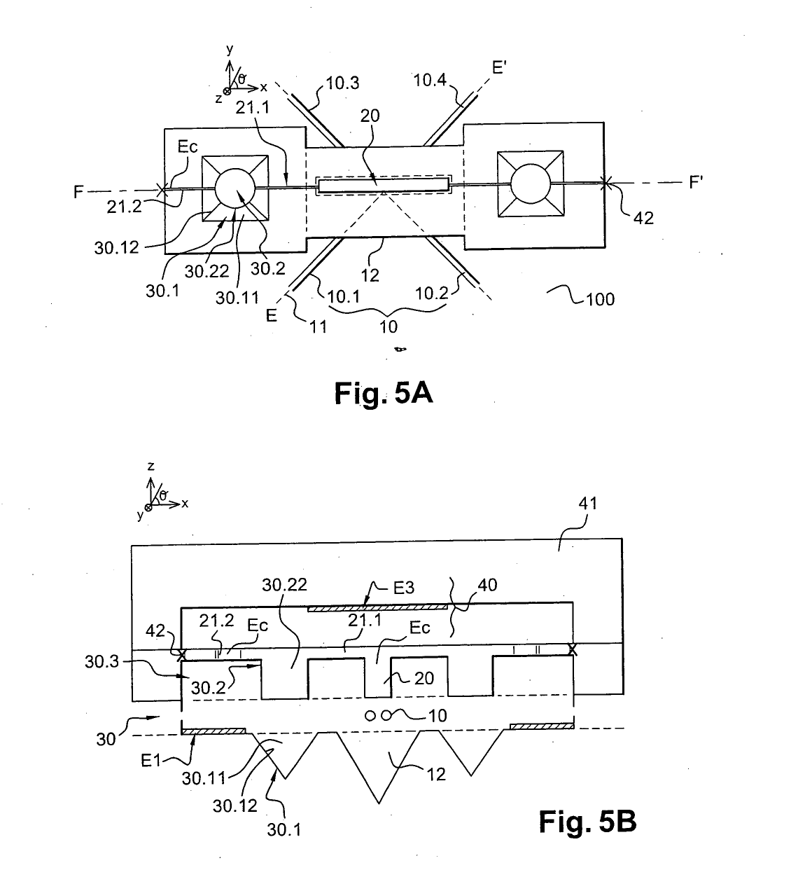

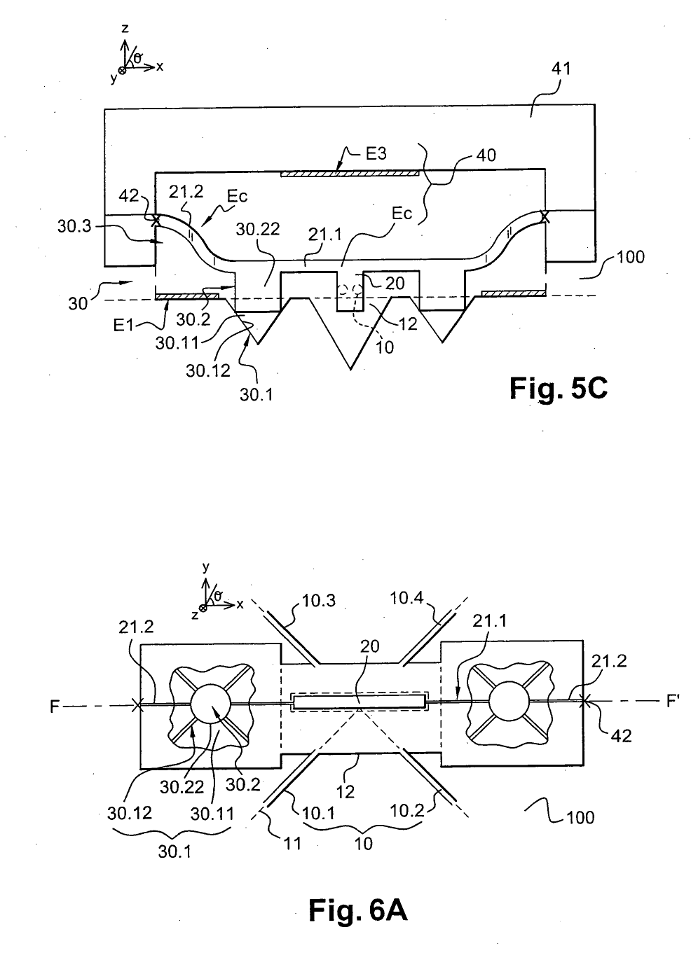

We will now consider variants of the second mechanical reference and the first mechanical reference. Refer to FIGS. 5A, 5B, 5C that diagrammatically show a top view and sectional views respectively before and after crossconnecting the first and second mechanical references of an optical device according to the invention.

The second mechanical reference 30.2 comprises one or several protuberances 30.22. The first mechanical reference 30.1 is formed from one or several housings 30.11, each of which will hold a protuberance 30.22 when the crossconnection is made. The housings 30.11, like the bottom of the cavity 12, are excavated from the substrate 100 that holds the optical guide structure 10. Each housing 30.11 is equipped with mechanical means 30.12 of guiding a protuberance 30.22 in a housing. In this example, the housings 30.11 are V grooves and the guide means 30.12 are the inclined walls of the grooves. Each protuberance 30.22 is in the form of a cylinder of revolution but other forms would be possible. Each protuberance 30.22 is guided by the walls of the grooves into which it penetrates and this guide contributes to positioning the optical element 20 with respect to the optical guide structure 10 in three dimensions. The protuberance 30.22 is thus centered by the walls of the V-groove.

Each protuberance 30.22 is fixed to the optical element 20 through a flexible connection 21.1. The optical element 20 is suspended above the cavity 12 into which it can enter, by a support 21, flexible at least along the z direction, connected to the optical guide structure 10. This flexible support 21 can encompass the flexible connection 21.1 as shown in FIG. 4 and be in the form of a connecting arm on each side of the optical element 20 formed of two segments 21.1, 21.2 located on each side of a protuberance 30.22.

In FIG. 5B, the second mechanical reference 30.2 and the first mechanical reference 30.1 have not been crossconnected; The optical element 20 is outside the cavity 12. In FIG. 5C, they have been crossconnected and the optical element 20 is in a position to intercept an optical beam 11 transported by a guided optical channel of the optical guide structure 10.

The means 30.3 for crossconnecting the second mechanical reference 30.2 with the first mechanical reference 30.1 are of the electrostatic type and comprise at least one pair of electrodes with a mobile electrode Ec fixed to the flexible support 21 and at least one fixed electrode E1 fixed to the substrate 100 that supports the optical guide structure 10. These electrodes E1, Ec extend in the plane of the optical guide structure 10 (xoy plane) and enable a movement along z. There are no other pairs of electrodes in the other planes for the crossconnection means due to the presence of the guide means. The means 40 of displacing the optical element 20 are shown as in FIG. 4.

The cavity 12 in which the guided optical channels of the optical guide structure 10 open up is also shown with a V-shaped bottom. These V shapes can easily be made using etching techniques, preferably on crystalline planes, in a substrate made of a semiconducting material.

The V-grooves may be bounded by walls oriented in the xoz plane or inclined walls as shown in FIG. 5A. These bounded grooves form a hollow pyramid with a square base. These inclined walls refine the positioning of the optical element with respect to the optical guide structure. In FIGS. 5A to 5C, the authorized movement lies in the xoz and xoy planes for translations and along at least the z-axis for rotation.

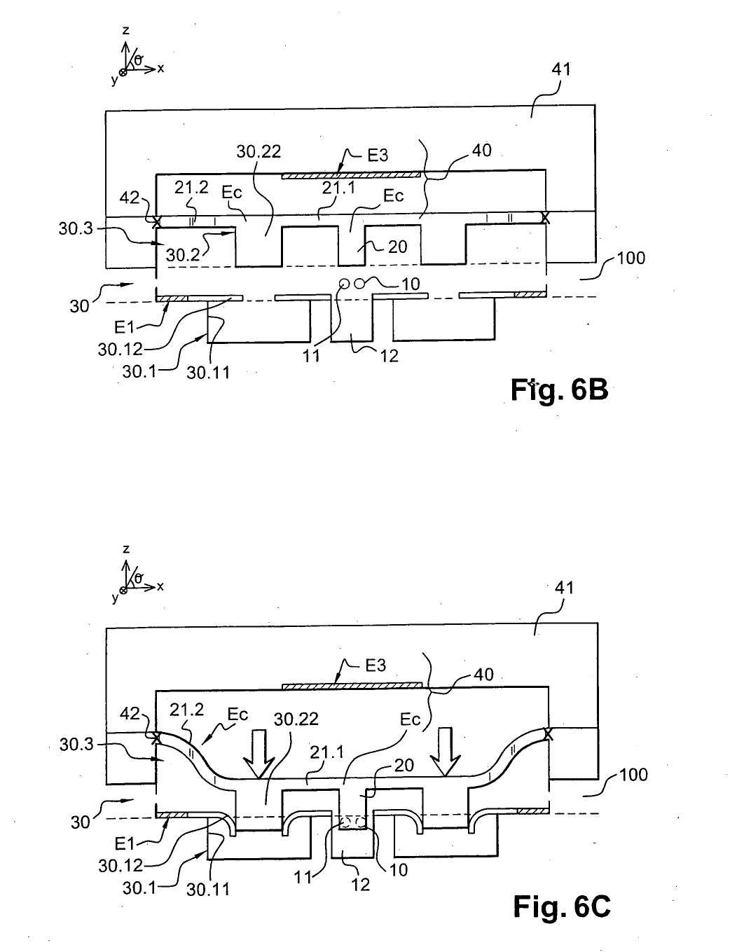

FIGS. 6A, 6B, 6C are comparable to FIGS. 5A, 5B, 5C, and the same movements are authorized. There is a difference at the first mechanical reference 30.1 that is always of the housing type. The second mechanical reference mobile 30.2 is formed as before from one or several protuberances 30.22, preferably in the form of a cylinder of revolution. Each protuberance 30.22 is designed to penetrate into a housing 30.11 equipped with means 30.12 for mechanical guiding of the protuberance 30.22. The well-shaped housings 30.11 are excavated from the substrate 100. The mechanical guide means 30.12 are in the form of several flexible tabs that hang into each housing from its opening when the protuberance is introduced into the housing. These flexible tabs 30.12 have a free end located in the housing 30.11. These flexible tabs 30.12 guide the protuberances when the second mechanical reference 30.2 and the first mechanical reference 30.1 are crossconnected. Their role is to center the protuberance 30.22 in its housing 30.11.

We will now describe different configurations of the optical guide structure 10. This optical guide structure comprises n guided optical channels 10.10 on one side of the optical element 20 that is inserted in the cavity 12 and m guided optical channels 10.20 on the other side of the optical element 20. n and m are integer numbers, and at least one of them is greater than or equal to one. This optical guide structure is plane (xoy plane).

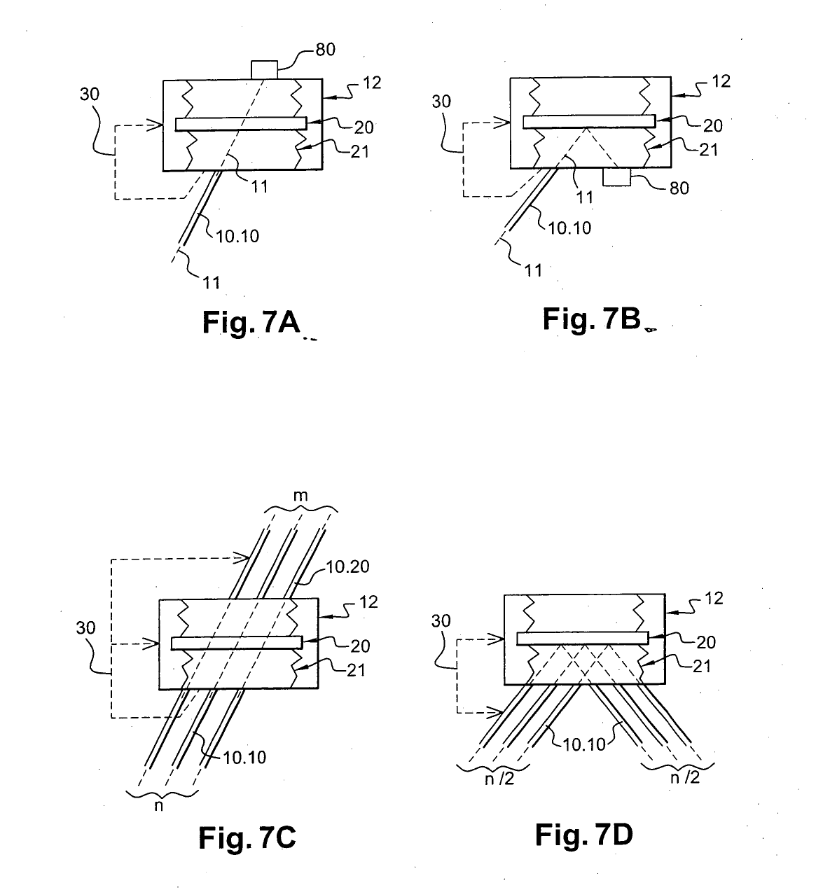

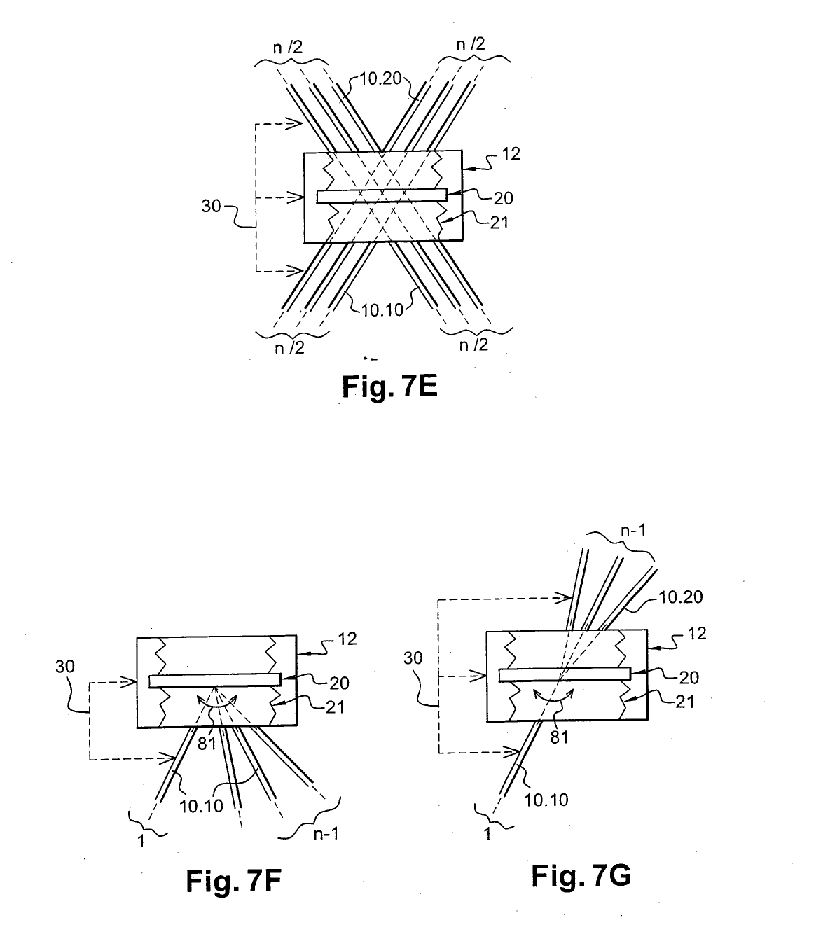

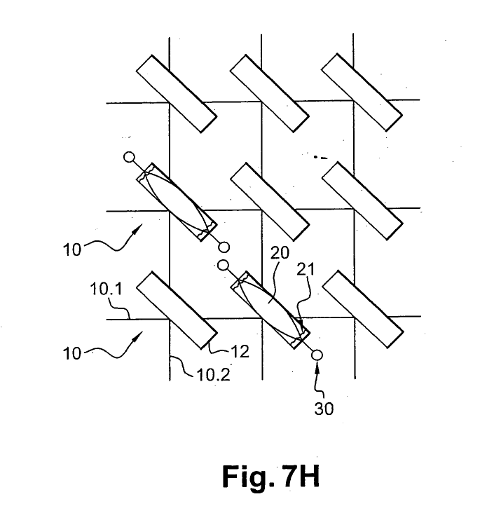

The simplest configuration only includes one guided optical channel 10.10 as shown in FIG. 7A. The guided optical channel 10.10 may be an optical fiber or an optical guide, and opens up into the cavity 12. There may be a device 80 prolonging it on the other side of the cavity, such as a light detector that will be illuminated by an optical beam 11 transported by the guided optical channel 10.10. The optical element 20 then acts as a shutter. When it is located in the cavity 12, it stops propagation of the optical beam 11 to the device 80. When it is outside the cavity 12, the beam 11 can reach the device 80. This state is illustrated in FIG. 7A.

In a variant illustrated in FIG. 7B, the device 80 may be placed on the same side as the guided optical channel 10.10 with respect to the optical element 20 inserted in the cavity 12. In this case, the optical element 20 may perform a function to reflect the optical beam 11 to the device 80. This is the state that is illustrated. The positioning device 30 has been sketched in FIGS. 7A to 7G.

FIGS. 2A, 2B show two guided optical channels on one side of the optical element and none on the other side. These guided optical channels are at an angle from each other. The optical element 20 acts as a reflector.

FIG. 4 show two optical channels on each side of the optical element 20 inserted in the cavity 12. The optical device is a switch that operates in reflection when the optical element 20 is in the cavity 12 and in transmission when the optical element 20 is outside the cavity 12.

In FIG. 7C, there are n guided optical channels 10.10 on one side of the optical element 20 inserted into the cavity 12 and m guided optical channels 10.20 on the other side. n is equal to m and is greater than or equal to one. Each of the m guided optical channels 10.20 prolongs one of the n guided optical channels 10.10. These optical channels 10.10, 10.20 form an angle with the optical element 20. This optical device operates as a shutter on n channels.

FIG. 7D is a generalization of the structure in FIG. 2 with two groups of n/2 guided optical channels 10.10 on the same side of the optical element 20 inserted into the cavity 12, these two groups being at an angle from each other. This type of optical device operates in reflection on n/2 channels.

FIG. 7E is a generalization of the structure of FIG. 4 with two groups of n/2 optical channels 10.10 being at an angle from each other and placed on one side of the optical element 20 inserted in the cavity 12 and two groups of n/2 optical channels 10.20 forming the same angle and placed on the other side. A group of n/2 guided optical channels 10.10 or 10.20 on one side of the optical element 20 prolongs a group of n/2 guided optical channels 10.20 or 10.10 placed on the other side of the optical element 20. This type of device operates as a switch on n channels, either in transmission or in reflection.

FIGS. 7F and 7G illustrate other configurations of the optical device according to the invention that now perform a 1×n switching function.

In FIG. 7F, the optical guide structure comprises firstly a single guided optical channel 10.10 and secondly a group of n−1 guided optical channels 10.10, on the same side of the optical element 20 placed in the cavity 12.

The optical element 20 may be a mirror. It may be in several angular positions around the z-axis such that each of the n guided optical channels 10.10 can be selected. The optical device operates in reflection and is reversible.

In FIG. 7G, there is a single guided optical channel 10.10 on one side of the optical element 20 inserted in the cavity 12, and on the other side there is a group of m (=n−1) guided optical channels 10.20. The optical element 20 may be a transparent or semi-transparent dielectric slide. It may be in several angular positions around the z-axis such that each of the m guided optical channels 10.20 can be selected. The optical device operates in transmission and is reversible.

The means of displacing the optical element 20 in rotation are not shown in detail in these two figures, they are represented diagrammatically by a double arrow 81.

This invention also relates to an optical mixer than comprises several optical devices thus characterized. These optical devices are arranged in rows and columns, the optical guide structure 10 comprising two guided optical channels 10.1, 10.2 arranged at a non-zero angle on the same side of the mobile optical element 20 and two optical channels 10.3 and 10.4 arranged at a non-zero angle on the other side of the mobile optical element 20. The different optical channels 10.1 to 10.4 open up into a cavity 12 and can also be used to optically connect the optical devices depending on the rows and/or columns. Figure 7H illustrates such an optical mixer. Its two mobile optical elements 20 are inserted into one of the cavities 12. The flexible supports are marked with reference 21 and the positioning device is marked with reference 30.

We will now describe an example embodiment of an optical device according to the invention. The optical device is comparable to that shown in FIGS. 4A and 4B with a single solid mobile electrode Ec formed from the mobile block, namely the mobile element, the flexible support, parts with edges and the flexible connection. However, there are differences.

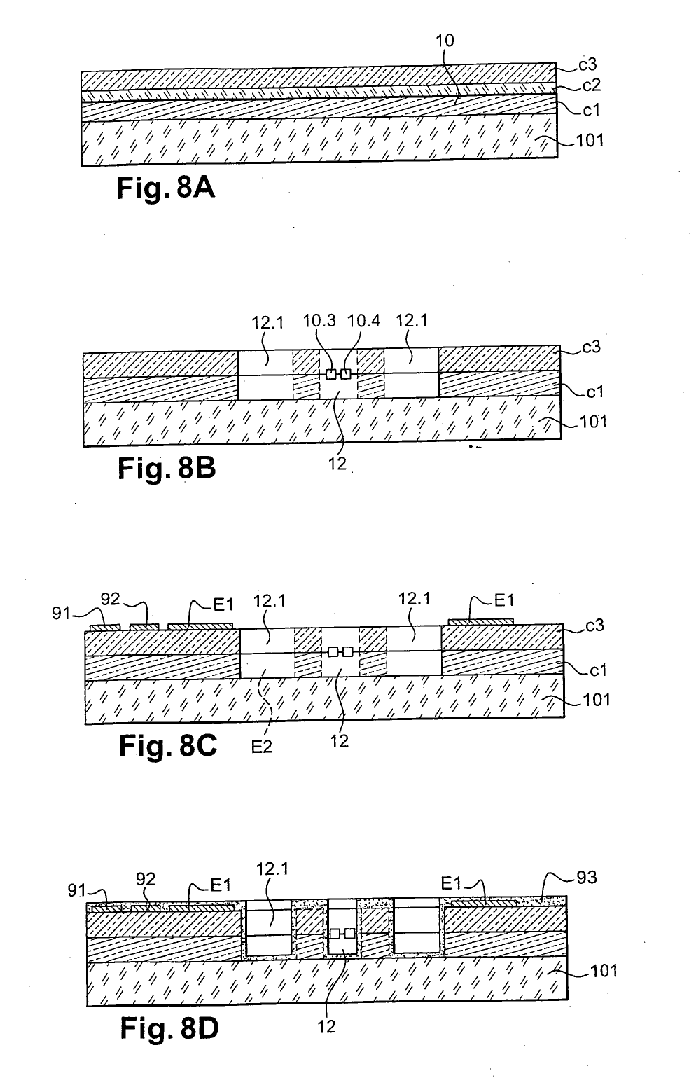

We will start by making the optical guide structure 10 on a first substrate 101. This optical guide structure 10 comprises four guided optical channels in cross formation each in the form of a flat optical guide with a core and a coating. A first layer c1 is deposited on the base substrate 101 for example made of silicon, and this layer is covered with a second layer c2 that will act as a core and will subsequently be etched to delimit the contour of the core. The core may have a circular or rectangular section depending on the technology used, in the silicon technology the section of the core tends to be rectangular and in the technology on glass it tends to be circular. The second layer c2 is covered by a third layer c3 that acts as a coating (FIG. 8A). This figure is a section along the CC′ axis shown in FIG. 4B. The guided optical channels 10.3, 10.4 are shown end to end since the cavity has not been formed at this stage.

The layers c1, c2, c3 may be made of different doped or undoped materials, the second layer c2 having a refraction index greater than the refraction index of the other layers c1, c3 so as to guide light. For example, these materials may be chosen from among glass, silicon oxide, silicon and polymers.

We will then use etching to delimit the cavity 12 that will contain the mobile optical element and the space 12.1 in which the second mechanical reference moves (in the form of parts with edges) and thus materialize the first mechanical reference that is a wall that delimits this space. FIG. 4B shows that this space 12.1 communicates with the cavity 12, but this is not compulsory. The space 12.1 and the cavity 12 are distinct. FIG. 8B shows a cross-section through the device along the DD′ axis in FIG. 4B. This etching may be an anisotropic dry etching. It stops on the first substrate 101. This Figure only includes a front cross-sectional view of the guided optical channel 10.2 and the guided optical channel 10.4.

We will then make the fixed electrodes E1, E2 of the means of crossconnecting the second mechanical reference with the first mechanical reference (FIG. 8C). These electrodes are conforming to the electrodes shown in FIGS. 4A, 4B. The electrode E2 cannot be seen since it is in the plane of the sheet. This electrode embodiment can be made by evaporation or sputtering, through a mechanical mask (not shown) made of a conducting material, for example based on aluminium, titanium, nickel or gold. Conducting pads 91, 92 for accessing each of the electrodes can be connected to these electrodes E1, E2.

We will now deposit a dielectric layer 93 on these electrodes E1, E2 and these pads 91, 92 to protect them during electromechanical operation of the optical device. This oxide layer may also be used for sealing this first substrate 101 with a second substrate 102 that will be described later. For example, a conforming oxide deposition of BPSG (Boron Phosphorus Silicate Glass) which is a silicon oxide doped with boron and phosphorus, or a similar oxide, can be made. A step to planarize the surface oxide layer may be performed to prepare the surface for sealing with the second substrate 102 (FIG. 8D).

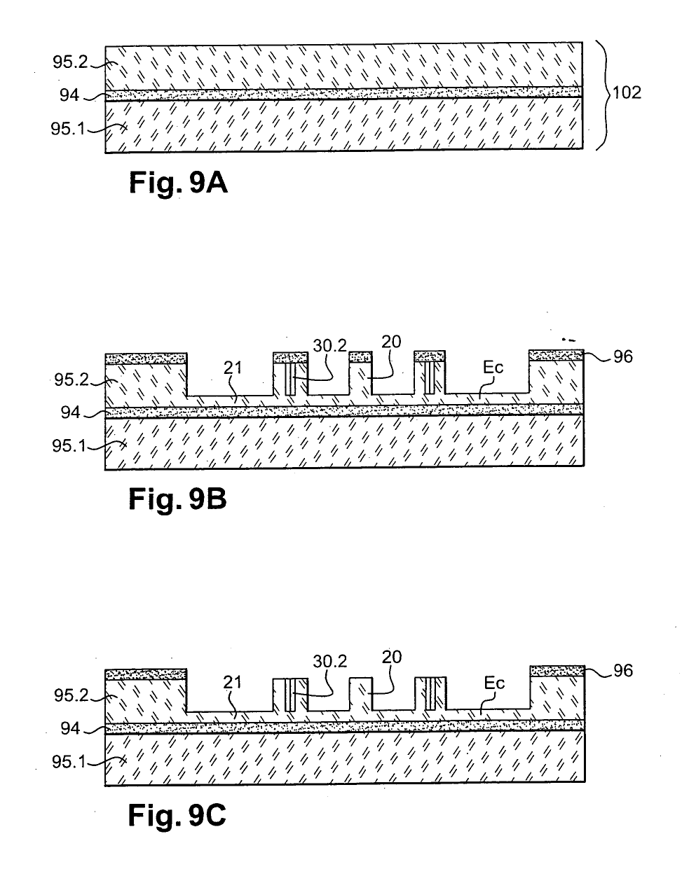

The starting point for the next step is a second substrate 102 comprising an intermediate dielectric layer 94 between two layers of semiconducting material; a lower layer 95.1 and an upper layer 95.2. For example, it may be a thick SOI (silicon on insulator) substrate 102 in which the thickness of the silicon layer 95.2 is about 20 micrometers and the thickness of the buried silicon oxide layer 94 is about 1 micrometer (FIG. 9A). The second mechanical reference 30.2, the flexible support 21 and if necessary the flexible connection (if it is not embedded in the flexible support) are delimited by etching (FIG. 9B). For example, an anisotropic dry etching may take place through an oxide mask 96, for example silicon oxide. Etching stops in the upper layer 95.2 made of semiconducting material.

The next step is to remove the oxide mask 96 on the etched parts that can move, namely the flexible support 21, the second mechanical reference 30.2 and the optical element 20, in other words the mobile block (FIG. 9C). This can be done by dry or wet etching of the oxide after protecting the remainder of the oxide layer, for example by a resin layer. It is assumed that the mobile block forms a mobile electrode Ec common to the crossconnection means and the displacement means.

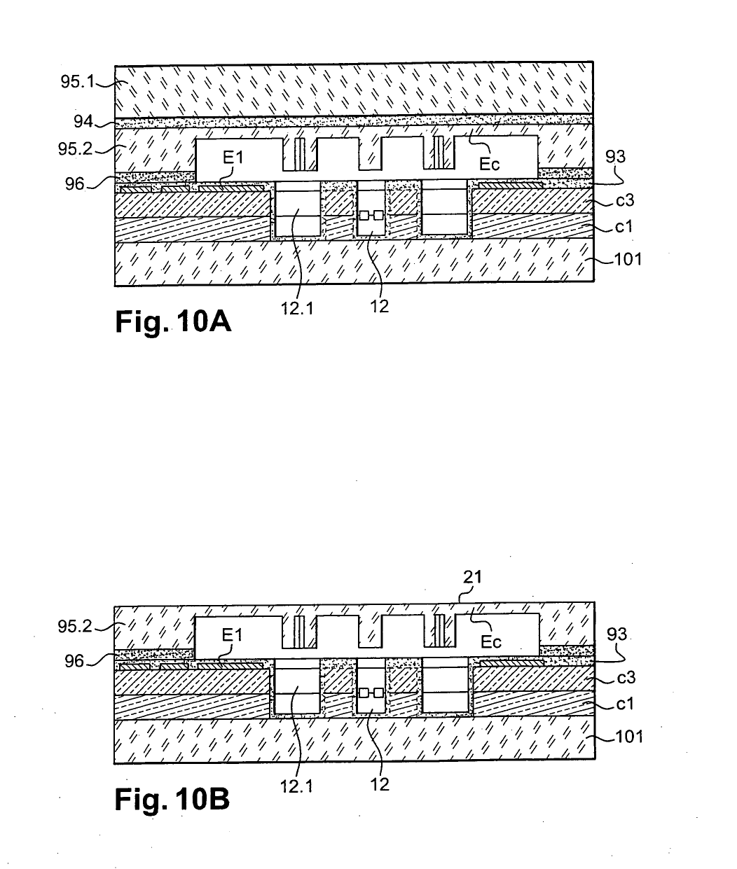

FIG. 10A illustrates the assembly between the first substrate 101 supporting the optical guide structure 10 and the second overturned substrate 102 supporting the mobile block. This assembly may be a molecular or similar seal, a eutectic seal, or an anodic seal. The assembly precision does not need to be very good.

The next step is to release the mobile block by thinning, by removing the lower semiconducting material layer 95.1 and the intermediate dielectric layer 94 and then delimiting their contour in the thickness of the upper layer of semiconducting material that was not etched in the step in FIG. 9B (FIG. 10B). These etchings may be done by anisotropic dry etching. Material from the second substrate is kept on each side of the flexible support 21, since these are the locations at which the seal with the first base substrate 101 is made.

This delimitation step of the contour of the mobile block can be difficult since it was already made mobile when the lower layer of semiconducting material 95.1 and the intermediate dielectric layer 94 were removed. The inverse procedure may be used, starting by delimiting the contour of the mobile block through the remaining thickness of the upper layer of semiconducting material 95.2 that was not etched in the step in FIG. 9B, the intermediate dielectric layer 94 and the lower layer of semiconducting material 95.1, and only then removing the intermediate dielectric layer 94 and the lower layer of semiconducting material 95.1. These two layers act as a stiffener. As a variant, only the intermediate dielectric layer 94 may be considered as being a stiffening layer. The lower layer of semiconducting material 95.1 may then be removed before the delimitation and the intermediate dielectric layer 94 may be removed after.

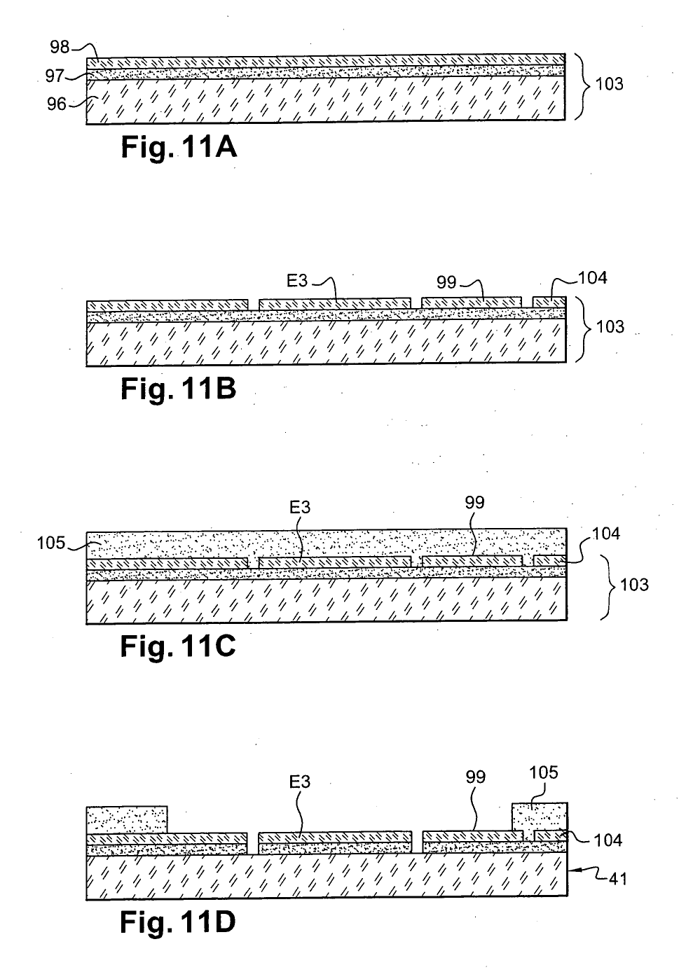

A third substrate 103 comprising a thick layer 96 of semiconducting material covered by a thin layer 97 of insulating material and a thin layer 98 of semiconducting material are used to make some of the means of displacing the optical element (FIG. 11A). This may be an SOI substrate, and its thin layers 97, 98 may be of the order of one micrometer thick.

The contour of the fixed electrode E3 of the means of displacing the optical element and an access pad 104 connected to the fixed electrode are etched in the thin layer 98 of semiconducting material (possibly doped to make it more conducting) (figure This fixed electrode E3 and this pad 104 are covered with a layer of dielectric material 105 (FIG. 11C). This may be a layer of silicon oxide. A step to planarize the surface of the layer of dielectric material 105 may be envisaged.

The walls on the inside of the cover 41 are formed in the layer of dielectric material 105, so as to delimit the control space (FIG. 11D). This working may be dry anisotropic etching of the layer of dielectric material 105. Etching exposes the fixed electrode E3 but not the pad 104.

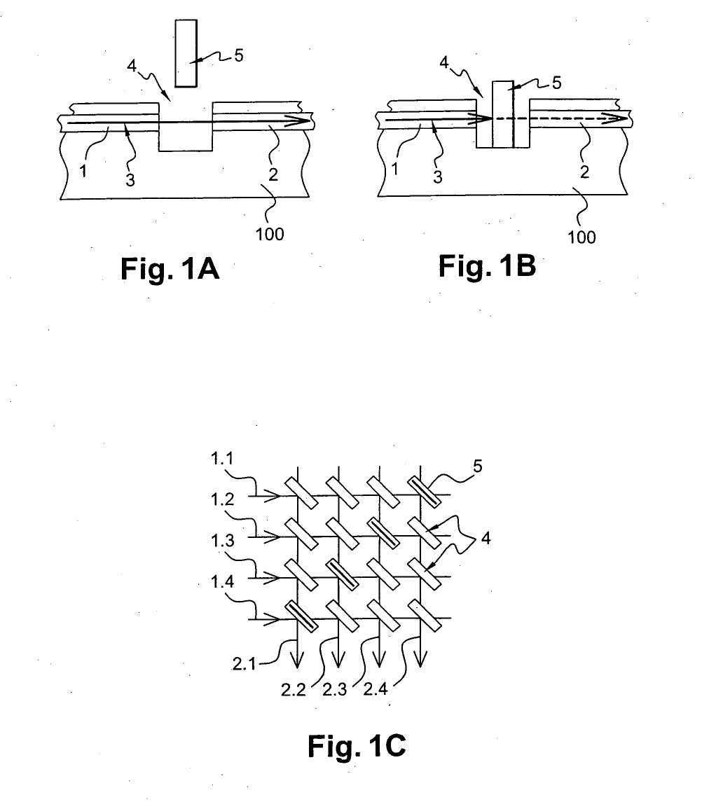

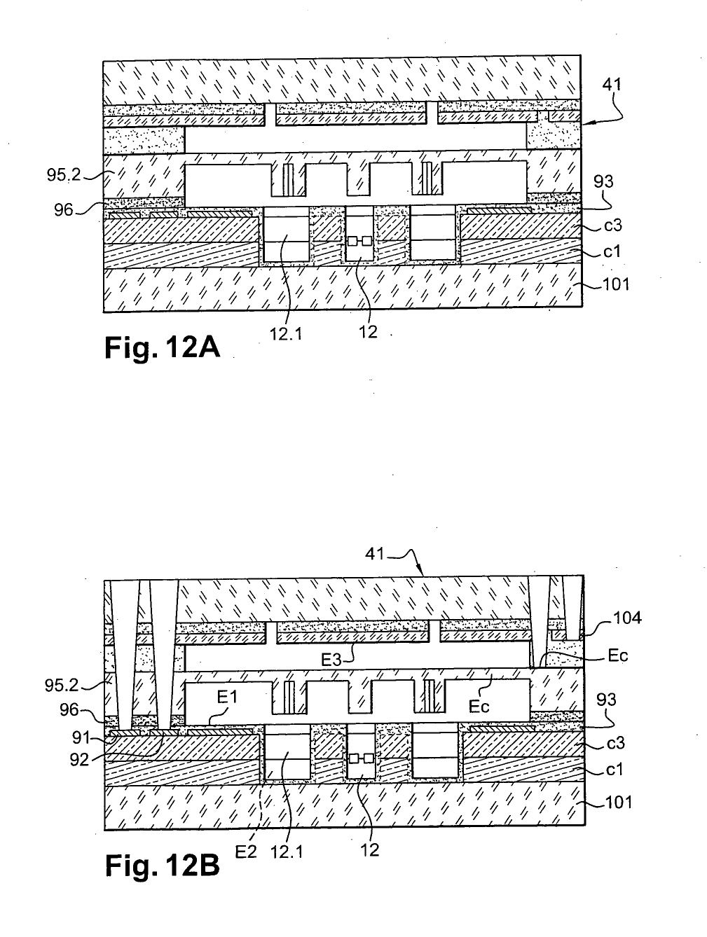

The step illustrated in FIG. 12A is an assembly of the formed substrate illustrated in FIG. 1D, after being turned over above the structure illustrated in FIG. 10B. The fixed electrode E3 is on top of the mobile block and therefore the mobile electrode Ec. The assembly may be a seal of the same types as those mentioned in the description of FIG. 10A.

Finally, an etching step is undertaken at the pads 91, 92 and at the electrode Ec and the pad 104 to rework the contacts of the various electrodes E1, E2, E3, Ec (FIG. 12B).

We will now consider an example of a method for manufacturing an optical device according to the invention comparable to that illustrated in FIG. 5, using the protuberances as the second mechanical reference and the V-grooves as the first mechanical reference, and a crossconnection essentially perpendicular to the plane of the optical guide structure.

We will start from a first substrate 101, for example made of silicon. It is covered with a conducting material 106, for example made of doped silicon, AlSi, or a metallic material such as aluminium or gold.

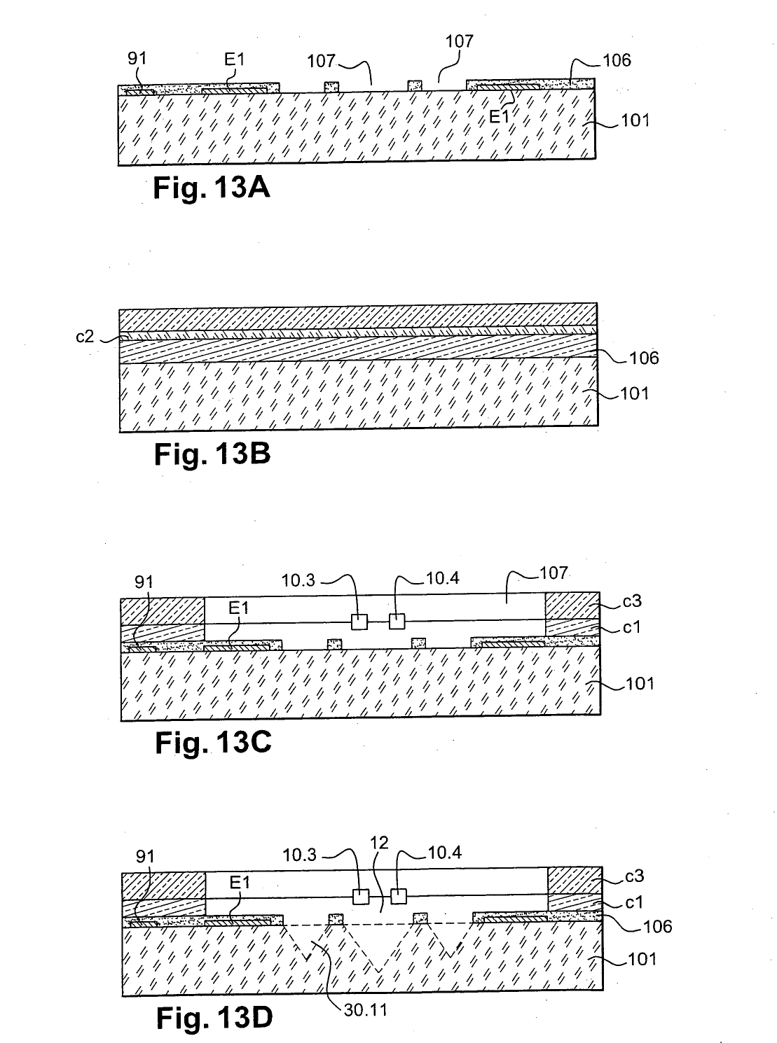

Photolithography and etching will be used to delimit the contour of the fixed electrodes E1 of the means of crossconnecting the second mechanical reference with the first mechanical reference. Conventionally, at least one pad 91 to access to these electrodes E1 is provided. The substrate 101 thus formed is covered by an insulating layer 106 that will act as a photolithography mask for etching the grooves and the cavity that will contain the mobile element (FIG. 13A). For example, this layer 106 may be made of silicon oxide and/or silicon nitride and is deposited by a plasma enhanced chemical vapor deposition (PECVD) process. Openings 107 corresponding to the contour of the grooves and the cavity are etched in this layer 106.

We will now make the optical guide structure in the same way as in the step in FIG. 8A. A first layer c1 is deposited that will act as a coating, it will be covered by a second layer c2 that will act: as a core for the guided optical channels. The second layer c2 is etched to delimit the contour of the core. The second layer c2 is covered by a third layer c3 that acts as a coating (FIG. 13B). This figure is a section along the EE′ axis of FIG. 5A.

A space 107 will be exposed by etching in the stack formed of layers c1 to c3, corresponding to a part of the cavity in which the guided optical channels of the optical guide structure open up together with a space in which the protuberances are located before crossconnecting the first and second mechanical references (FIG. 13C). This FIG. 13C that is a section along the FF′ axis in FIG. 5A, shows two guided optical channels 10.3, 10.4 in cross-section. The next step is to etch the bottom of the cavity 12 and the V-grooves 30.11 in the first substrate 101 (FIG. 13D).

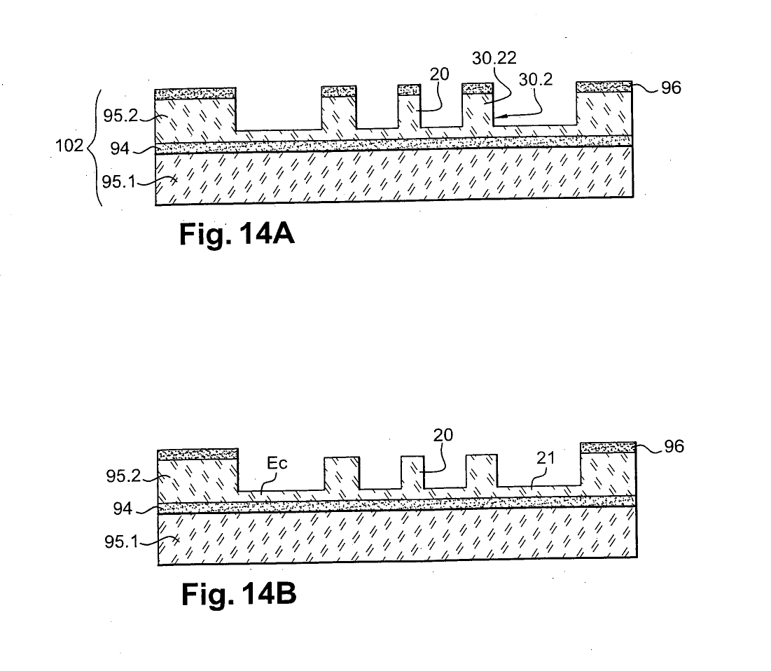

Protuberances 30.22 in the second mechanical reference 30.2, the flexible support 21 and if necessary the flexible connection (if it is not embedded in the flexible support) are delimited by etching the optical element 20 in a second substrate 102 conforming with that described in FIG. 9A (see FIG. 14A). For example, etching may be dry anisotropic etching through an oxide mask 96, for example made of silicon oxide. Etching is stopped in the upper layer 95.2 of semiconducting material.

The next step is to expose the oxide mask 96 on the etched parts that may need to move (subsequently called the mobile block): in other words the flexible support 21, the second mechanical reference 30.2 and the optical element 20 (FIG. 14B). This etching may be done by dry or wet etching of the oxide after protecting the remainder of the oxide layer, for example by a resin layer.

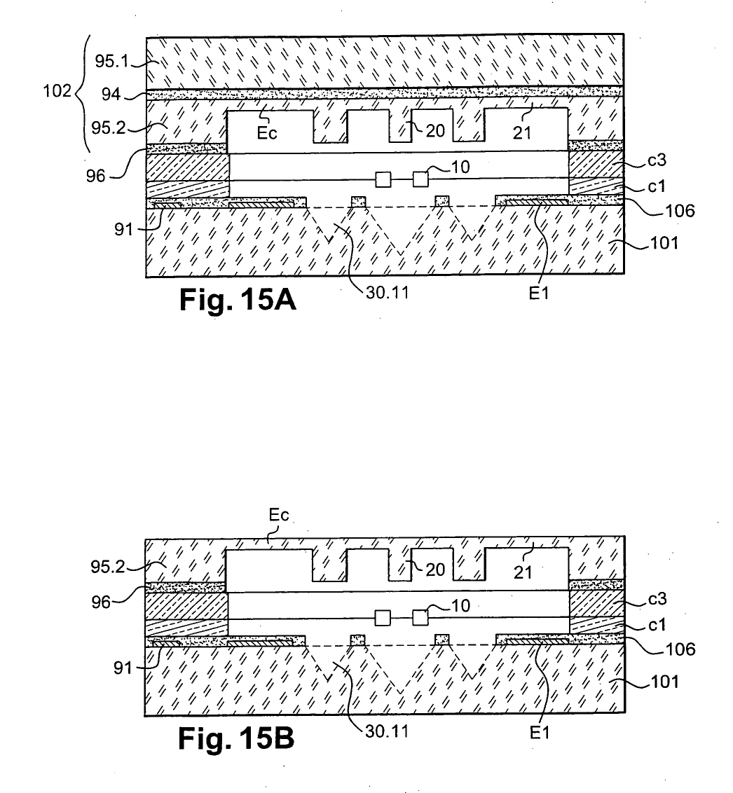

FIG. 15A illustrates the assembly between the first substrate 101 supporting the optical guide structure 10 and the second overturned substrate 102 supporting the mobile block. This assembly may be made as described in FIG. 10A.

FIG. 15B illustrates release of the mobile block, as shown in FIG. 10B.

Refer to FIGS. 11A to 11D that illustrate the explanation of partial manufacturing of means of displacing the optical element starting from a third substrate 103.

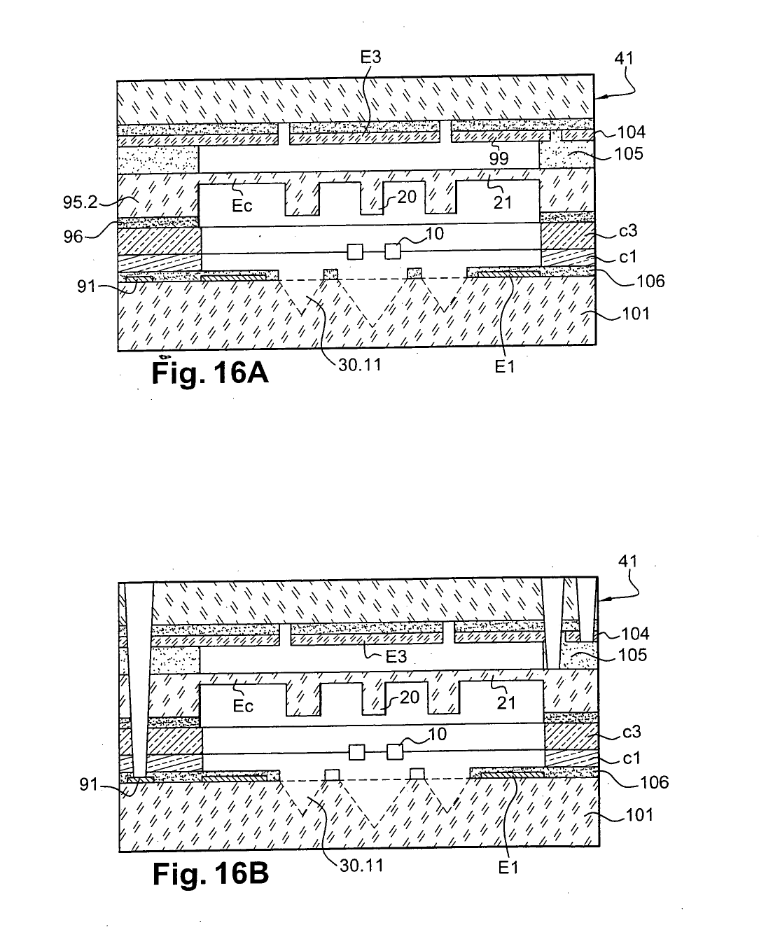

FIG. 16A illustrates the assembly of the formed substrate illustrated in FIG. 1D, after being overturned above the structure illustrated in FIG. 15B. The fixed electrode E3 is above the mobile block. The assembly may be a seal of the same type as those described with reference to FIG. 10A.

FIG. 16B illustrates an etching step at pads 91, 104 and the electrode Ec to rework the contacts of the various electrodes E1, E3, Ec.

Although several embodiments of this invention have been shown and described in detail, it will be understood that various changes and modifications can be made particularly to the shape of the positioning device, the mobile optical element and the optical guide structure without departing from the scope of the invention. It would also be possible to consider inverting the protuberances and the housings, with the housings materializing the second mechanical reference and the protuberances materializing the first mechanical reference.

### DOCUMENTS MENTIONED

[1]
“Bistable 2×2 and multistable 1×4 micromechanical fibre-optic switches on silicon”, P. Kopka, M. Hoffmann, E. Voges, MOEMS 99, Mainz (D), Aug. 30-Sep. 1, 1999.
[2]
“Low voltage, wavelength and polarisation independent micro-opto-mechanical switch integrated on silicon”, E. Ollier, P. Mottier, ECIO 97, Stockholm (Sweden), Apr. 2-4,1997.
[3]
“Optical-layer networking: opportunities for and progress in lightwave micromachines”, L. Y. Lin, E. L. Goldstein, OFC 2000, Baltimore (US), Mar. 7-10, 2000.
[4]
“4×4 fiber optic matrix switch based on MOEMS”, C. Marxer, Y. Girardin, N. F. De Rooij, MOEMS 99, Mainz (D), Aug. 30-Sep. 1, 1999.
[5]
“Free-space micromachined optical switches with submillisecond switching time for large-scale optical crossconnects”, L. Y. Lin, E. L. Goldstein, R. W. Tkach, IEEE photonics Technology Letters, Vol. 10, No. 4, April 1998.
[6]
“Micro-opto-electro-mechanical switch for optical network” M. Mita, Ph. Helin, D. Miyauchi, H. Toshiyoshi, H. Fujita, LIMMS Activity Report, March 1998-March 1999.
[7]
“Development of a multi-channel 2×2 switch” Y. Kato, T. Norimatsu, O. Imaki, T. Sasaki, K. Kondo, K. Mori, Optical MEMS Conference, 20-23. Aug. 2002, Lugano, Switzerland.
[8]
“An SOI optical microswitch integrated with silicon waveguides and touch-down micromirror actuators” Young-Hyun Jin and al, Optical MEMS 2000 Conference, 21-24 August, Kauai, Hi., USA.
[9]
“Micromachined curling optical switch array for PLC based integrated programmable add/drop multiplexer” M. Katayama and al, OFC 2001 Conference, March 2001, Anaheim, Calif. USA.
[10]
“4×4 matrix switch based on MEMS switches and integrated waveguides” L. Dellmann and al, Transducers 01 Conference, 10-14 Jun. 2001, Munich, Germany.
[11]
EP 0 961 150 A2.
[12]
U.S. Pat. No. 5,148,506.
[13]
FR-2 817 050.
[14]
“Global revolution for Nanovation” ECOC 2000 Exibition News, 2000.

1. An optical device comprising an optical guide structure (10) for at least one optical beam (11), a mobile optical element (20) designed to interact or not interact with the guided optical beam using optical element displacement means (40), a flexible support (21) connecting the optical element to the optical guide structure, characterized in that it comprises a device (30) for positioning the optical element with respect to the optical guide structure, comprising a first mechanical reference (30.1) connected to the optical guide structure and a second mechanical reference (30.2) connected to the mobile optical element, and means (30.3) of crossconnecting the second mechanical reference and the first mechanical reference, this crossconnection enabling movement of the optical element according to at least one plane containing the first and second mechanical references (30.1, 30.2) and the optical guide structure (10).

2. Optical device according to claim 1, characterized in that the optical element (20) is capable of moving in translation and/or rotation.

3. Optical device according to claim 1, characterized in that crossconnection means (30.3) and the displacement means (40) are distinct.

4. Optical device according to claim 1, characterized in that the crossconnection means (30.3) are passive, with the crossconnection being made during manufacture of the optical device.

5. Optical device according to claim 1, characterized in that the crossconnection means (30.3) are active and can be activated before and/or during and/or after displacement of the mobile optical element (20).

6. Optical device according to claim 5, characterized in that the crossconnection means (30.3) comprise at least one pair of electrodes (Ec, E1), and one (Ec) of the electrodes in the pair is mobile.

7. Optical device according to claim 6, characterized in that the crossconnection means (30.3) comprise several pairs of electrodes (Ec1, E1, Ec2, E2) the electrodes in the different pairs extending in approximately perpendicular planes.

8. Optical device according to claim 1, characterized in that the second mechanical reference (30.2) is flexibly connected to the mobile optical element (30.2) through a flexible connection (30.4).

9. Optical device according to claim 8, characterized in that the flexible connection (30.4) is thinner than the mobile electrode (Ec1) of the crossconnection means (30.3).

10. Optical device according to claim 1, characterized in that the flexible support (21), the second mechanical reference (30.2) connected to the mobile optical element (20) form a mobile block.

11. Optical device according to claim 10, characterized in that the mobile block supports or forms at least one mobile electrode (Ec1) of the crossconnection means (30.3) and a mobile electrode (Ec3) of the displacement means (40).

12. Optical device according to claim 1, characterized in that the mobile optical element (20) can enter into or move out of a cavity (12) when it is displaced, and the optical guide structure (10) opens up into this cavity (12).

13. Optical device according to claim 12, characterized in that the cavity (12) contains an index adaptation fluid.

14. Optical device according to claim 1, characterized in that the means of displacement (40) include a fixed electrode (E3) fixed to a protective cover (41) of the mobile optical element.

15. Optical device according to claim 1, characterized in that the first mechanical reference (30.1) and the second mechanical reference (30.2) are chosen from among one or several surfaces, one or several parts (30.20) with edges or points, or a combination of these elements.

16. Optical device according to claim 1, characterized in that the first mechanical reference (30.1) and the second mechanical reference (30.2) are chosen from among one or several protuberances (30.22), a housing (30.11) for each protuberance or a combination of these elements.

17. Device according to claim 16, characterized in that the housing (30.11) is equipped with guide means (30.12) for the protuberance (30.22).

18. Device according to claim 16, characterized in that the housing (30.11) is a V groove.

19. Optical device according to claim 18, characterized in that the guide means (30.12) are the walls of the V groove.

20. Optical device according to claim 17, characterized in that the guide means (30.12) are flexible tabs.

21. Optical device according to claim 1, characterized in that the optical guide structure (10) comprises n guided optical channels (10.10) on one side of the mobile optical element (20) mobile and m optical channels (10.20) on the other side of the mobile optical element, where n and m are integers, at least one of them being greater than or equal to one.

22. Optical device according to claim 21, characterized in that a guided optical channel (10.10, 10.20) is an optical guide or an optical fiber.

23. Optical device according to claim 1, characterized in that the mobile optical element (20) is a semi-reflecting optical slide, a mirror, an shutter, a prism or a lens.

24. Optical mixer characterized in that it comprises several optical devices according to claim 1, arranged in rows and columns, the optical guide structure (10) of each device comprises two guided optical channels (10.1, 10.2) at a non-zero angle on one side of the mobile optical element (20) and two guided optical channels (10.3, 10.4) arranged at a non-zero angle on the other side of the mobile optical element (20) and the said optical devices are connected in rows and/or in columns through their corresponding optical channels.

25. Method of making an optical device according to claim 1, characterized in that it includes the following steps:
on a first substrate (101), manufacture of the optical guide structure (10),
etching of a cavity (12) in which the optical guide structure opens up and production of the first mechanical reference (30.1),
production of electrodes (E1, E2) for the crossconnection means,
starting from a second substrate (102), delimitation of a mobile block including the second mechanical reference (30.2) connected to the optical element (20) and the flexible support (21),
assembly of the first substrate (101) and the second turned over substrate (102),
release of the mobile block, keeping a mechanical connection with the first substrate (101),
starting from a third substrate (103), roduction of an electrode (E3) for the displacement means (40),
assembly of a cover (41) above the second substrate, the electrode (E3) of the displacement means being located under the cover (40).

26. Method according to claim 25, characterized in that the electrodes are protected by a dielectric material (93, 96).

27. Method according to claim 25, characterized in that the second substrate (102) and the third substrate (103) are SOI substrates.

28. Method according to claim 25, characterized in that the step to release the mobile block includes thinning.

29. Method according to claim 25, characterized in that the electrodes (E1, E2) are deposited on the first substrate (101) before the guide structure (20) is made and before the cavity (12) in which the optical guide structure (10) opens up is etched.

30. Method according to claim 29, characterized in that the etching step is followed by a V groove etching step in the first substrate (101), these grooves materializing the first mechanical reference (30.1).

31. Method according to claim 25, characterized in that the electrodes (E1, E2) are made after the etching step.
